(19) United States
(12) Patent Application Publication
(10) Pub. No.: US 2022/0083652 A1
(43) Pub. Date: Mar. 17, 2022

(54) SYSTEMS AND METHODS FOR FACILITATING CYBERSECURITY RISK MANAGEMENT OF COMPUTING ASSETS

(71) Applicant: VIRTA LABORATORIES, INC., Alexandria, VA (US)

(72) Inventors: Benjamin Andrew Ransford, Seattle, WA (US); Andrew Whitehouse Deorio, Dexter, MI (US); Henrik Holm, Kalamazoo, MI (US); Mohammad Kayali, Seattle, WA (US)

(73) Assignee: VIRTA LABORATORIES, INC., Alexandria, MI (US)

(21) Appl. No.: 17/420,343

(22) PCT Filed: Jan. 3, 2020
(86) PCT No.: PCT/IB2020/050038

§ 371 Date: Jul. 1, 2021

Related U.S. Application Data
(60) Provisional application No. 62/788,030, filed on Jan. 3, 2019.

(51) Int. Cl. G06F 21/55

(52) U.S. Cl. CPC G06F 21/552; G06F 2221/034

(57) ABSTRACT

Disclosed herein is a method for facilitating cybersecurity risk management of computing assets, in accordance with some embodiments. Accordingly, the method may include a step of receiving, using a communication device, asset information from a computing asset. Further, the method may include a step of retrieving, using a storage device, secondary asset information from a third-party database. Further, the method may include a step of analyzing, using a processing device, the asset information and the secondary asset information based on at least one predetermined criterion. Further, the method may include a step of determining, using the processing device, a risk profile corresponding to each predetermined criterion based on the analyzing Further, the method may include a step of generating, using the processing device, a risk notification based on the determining. Further, the method may include a step of transmitting, using the communication device, the risk notification to a user device.

### FIELD OF THE INVENTION

Generally, the present disclosure relates to the field of data processing. More specifically, the present disclosure relates to systems and methods for facilitating cybersecurity risk management of computing assets.

### BACKGROUND OF THE INVENTION

Technology has positively advanced substantially in the past decade where a majority of devices can be interconnected and monitored through an online system. Data can be retrieved from a device and transferred to an online system, and some devices can be controlled by an online system. Examples of devices that can be monitored and/or controlled through a system include, but are not limited to, medical devices and nuclear devices. The process of monitoring and/or controlling a device through an online system makes it easier to manage multiple devices. Through hacking, unwanted users can retrieve important information from the devices and/or control the devices. This can lead to negative outcomes. For example, important information about a medical patient can be stolen by the unwanted user or the unwanted user can sabotage a nuclear power plant. Users can implement a cybersecurity system or take other steps in order to prevent the hacking of medical devices or similar situations from occurring. Further, the devices for which the cybersecurity system is implemented are called assets. However, users may not know what assets (computing assets) are at risk and what steps to take in order to properly protect the assets at risk.

Therefore, there is a need for improved systems and methods for facilitating cybersecurity risk management of computing assets that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating cybersecurity risk management of computing assets, in accordance with some embodiments. Accordingly, the method may include a step of receiving, using a communication device, asset information from a computing asset. Further, the computing asset is configured for generating the asset information. Further, the method may include a step of retrieving, using a storage device, secondary asset information associated with the computing asset from a third-party database. Further, the method may include a step of analyzing, using a processing device, the asset information and the secondary asset information based on at least one predetermined criterion. Further, the method may include a step of determining, using the processing device, a risk profile corresponding to each predetermined criterion associated with the computing asset based on the analyzing. Further, the method may include a step of generating, using the processing device, a risk notification associated with the computing asset based on the determining. Further, the method may include a step of transmitting, using the communication device, the risk notification to at least one user device.

Further disclosed herein is a system for facilitating cybersecurity risk management of computing assets, in accordance with some embodiments. Accordingly, the system may include a communication device a processing device, and a storage device. Further, the communication device may be configured for receiving asset information from a computing asset. Further, the communication device may be configured for transmitting a risk notification to at least one user device. Further, the storage device may be configured for retrieving secondary asset information associated with the computing asset from a third-party database. Further, the processing device may be configured for analyzing the asset information and the secondary asset information based on at least one predetermined criterion. Further, the processing device may be configured for determining a risk profile corresponding to each predetermined criterion associated with the computing asset based on the analyzing. Further, the processing device may be configured for generating the risk notification associated with the computing asset based on the determining.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating cybersecurity risk management of computing assets, in accordance with some embodiments.

FIG. 3 is a flowchart of a method for facilitating cybersecurity risk management of computing assets, in accordance with some embodiments.

FIG. 4 is a flowchart of a method of facilitating the determination of a risk profile based on additional asset information, in accordance with some embodiments.

FIG. 5 is a flowchart of a method 500 for facilitating the determination of priority of computing assets for performing actions, in accordance with some embodiments.

FIG. 6 is a flowchart of a method for facilitating the generation of an impact log for a vulnerability and a remediation action, in accordance with some embodiments.

FIG. 7 is a flowchart of a method for facilitating the determination of a risk profile associated with a computing asset based on network information of the computing asset, in accordance with some embodiments.

FIG. 8 is a flowchart of a method for facilitating the determination of a risk profile based on a user-determined criterion, in accordance with some embodiments.

FIG. 9 is a flowchart of a method for facilitating the determination of a risk profile associated with a computing asset based on user data, in accordance with some embodiments.

FIG. 10 is a flowchart of a method for facilitating the modification of a predetermined criterion based on a risk weight, in accordance with some embodiments.

FIG. 11 is a flowchart of a method for facilitating the generation of a risk management report based on a regulation, in accordance with some embodiments.

FIG. 12 is a block diagram of a system of facilitating cybersecurity risk management of computing assets, in accordance with some embodiments.

FIG. 13 is a flowchart of a method of facilitating cybersecurity risk management of computing assets, in accordance with some embodiments.

FIG. 14 is a flowchart of a method of “Pulse Feed” sub-process, in accordance with some embodiments.

FIG. 15 is a flowchart of a method of “Health Insurance Portability and Accountability Act (HIPAA) Report” sub-process, in accordance with some embodiments.

FIG. 16 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems and methods for facilitating cybersecurity risk management of computing assets, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, and at least one sensor. Examples of the one or more client devices and/or the server computer may include, a desktop computer, a laptop computer, a tablet, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), and so on. Further, one or more client devices and/or the server computer may be configured for executing a software application such as, for example, but not limited to, an operating system (e.g. Windows, macOS, Unix, Linux, Android, etc.) in order to provide a user interface (e.g., GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or possession of one or more embodied characteristics unique to the user (e.g., biometric variables such as but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between the performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems and methods for facilitating cybersecurity risk management of computing assets. Further, the present disclosure describes a risk assessment and prioritization for assets (computing assets) that may be susceptible to cyber-attacks. The disclosed system provides a risk assessment based on a set of risk factors for each asset associated with an organization or facility. Further, the risk assessment may include a mathematically determined risk score for each asset and recommendations on what steps to take in order to properly protect the assets at risk. Additionally, the disclosed system continuously monitors each asset and provides updates when there is new information to be incorporated into the risk profiles of the assets in order to ensure that each asset is associated with a risk profile and prioritization according to its susceptibility to cyber-attacks. The disclosed system provides risk assessments that may educate users on how to deal with assets that are susceptible to cyber-attacks based on the risk profile for each asset. The disclosed system further includes a vulnerability scan sub-process which allows a user to retrieve and identify an arbitrary asset with the vulnerability-scanning software. The information retrieved by the scanner device is relayed to the remote server and stored on the remote server. Moreover, this allows the disclosed system to automatically, or manually with user involvement, update the risk factors and the risk score of an arbitrary asset if any changes were made to the arbitrary asset.

Further, the present disclosure further describes a sub-process for discovering and identifying network-connected medical devices by observing network traffic and emitting summary data to another system. Further, the user operates network switching or routing equipment that orchestrates traffic flows within the organization via either hardware input/output ports or wireless network access points. Such equipment may be configured to reproduce, or “mirror” traffic from one or more sources to an output port. Such a configuration may be referred to by “port mirroring” or “SPAN.” The disclosed system, which may include a hardware or a software or a combination, may be attached to an output port, which gives the ability to receive traffic that may be not destined for the disclosed system. In this arrangement, the disclosed system may be observing a network segment.

When devices communicate on the network segment that the disclosed system may be observing, the disclosed system interprets each unit of network traffic (called frames or packets) and extracts descriptive clues that may identify either the sender or receiver of the traffic (its endpoints). For each clue, the disclosed system determines whether the communication endpoints are appearing in observed traffic for the first time (“discovery”). Such clues may also contain information that can unambiguously identify qualities of either endpoint, such as manufacturer, model, descriptive name, or software version (“identification”). A user may also direct the disclosed system to send out-of-band traffic to a network segment to elicit probe responses from previously known and unknown endpoints (“manual discovery”).

The disclosed system may be specially equipped to interpret several protocols that are unique to healthcare information systems, such as the HL7 and DICOM communication protocols. For each packet in the network segment's traffic matching an optionally user-specified filter, the disclosed system examines the beginning of the packet (the “header”) to determine whether the format of the communication warrants deeper inspection, i.e., whether it can be interpreted as one of the supported communication protocols. If the header of a packet does not match any of the known formats, the disclosed system ignores the packet.

The disclosed system periodically calculates a summary of the set of clues it has observed about endpoints, including both discovered and identified assets, then sends the summary to a separate system for further analysis, such as behavioral analysis (do the clues suggest that an endpoint is doing something it does not normally do?), identity inference (do the clues, taken with an existing body of knowledge, provide additional identifying information about an endpoint already in a database?), disambiguation (do the clues help the separate system determine that a specific entity is, in fact, two or more entities?), counting (do the clues help the separate system accurately assess the number of endpoints on network segments it is tracking?), data enrichment (the clues may add information about endpoints that may be useful in later analysis, e.g., forensic analysis after an incident).

The present disclosure further describes a sub-process for associating physical tags attached to computing devices with information about the cybersecurity status of said devices. The user deploys a variety of computing devices that may exhibit cybersecurity vulnerabilities, such as exploitable weaknesses in software, disclosure of sensitive information, inappropriate permissions inviting misuse, or missing important updates. In some settings, the user may operate thousands of such devices and use asset-management software to track risks and vulnerabilities pertinent to the devices.

The disclosed system allows a user to receive notice of these vulnerabilities while in a physical space such as a room or hallway. During a regular maintenance activity, the user attaches an off-the-shelf commodity RFID tag to each device to be tracked and inputs tag information to an asset management system to associate the tags with the assets. The input may be either manual via a keyboard or mouse, or automatic via an RFID reader that may be connected to the asset-management system. Each RFID tag bears a unique identifier so that no two computing devices to be tracked are associated with the same RFID tag identifier. The user may deploy RFID antennas in a desired area of operation, or the user may carry a handheld RFID reader with integrated antenna. The user controls the state of the RFID readers (reading or idle) through an “orchestration” software component that can manage one or more RFID readers simultaneously. The RFID readers use a radio protocol to gather unique identifiers from nearby tags (“reading” the tags). Each reader reports the tags' unique identifiers, via the orchestration component, to the asset-management system, which searches its own database for devices associated with the reported tags.

If the asset-management system finds a device associated with a given tag, it looks up security vulnerabilities or alerts associated with that device. If there are any such vulnerabilities or alerts, these are presented on a screen proximal to the user (e.g., while the user is physically near the tags and devices in question). The screen may be a handheld device such as a tablet or smartphone. In such a way, the user is made aware of vulnerabilities in nearby devices and can collect these devices to perform maintenance.

The use of Virta Labs™ BlueFlow Pulse threat feed as a portal for medical device manufacturers:

BlueFlow's Pulse threat feed may be used as a “clearinghouse” that eliminates the need for a Health Delivery Organization (HDOs, such as hospitals) to check the many “middleman” clearinghouses (such as NVD and H-ISAC) or manufacturer websites to learn of security threats or software patches. Further, the threat information may be gathered from numerous sources, including manufacturer websites and public sites, and sent by Virta Labs or partners through instances of BlueFlow software. Further, the Pulse threat feed would provide a mechanism for HDOs to receive software updates, patches and security alerts directly from medical device manufacturers in a manner that meets the needs of the HDOs, physicians and the FDA.

Currently, the HDO must sift through various sources to locate security threats to their devices and, even then, there is “alert fatigue” and it often is difficult to determine whether a particular threat applies to the HDO' s own specific devices. Medical device manufacturers could send important information directly to the HDO through BlueFlow's feed, rather than forcing the HDO to look for it elsewhere, thereby creating a more efficient and reliable solution to minimize the risk of cyber-attacks on medical devices.

The Virta Labs™ “Pulse” feed, currently used to convey vulnerability information to users of BlueFlow software, can serve as a conduit for other kinds of information from medical device manufacturers, including software updates, software patches, general threat information (e.g., a Pulse feed item can match “all infusion pumps” or “all Honeywell items” or a specific manufacturer, model, or software version), and specific remediation advice. The Virta Labs™ BlueFlow may create a workspace and a workflow that allows the HDO to match the information coming directly to it from the manufacturer to the specific devices at its own facility. The workflow feature of BlueFlow permits the HDO to prioritize the application of software updates and patches based on factors such as safety risk, privacy risk due to storage or processing of protected health information (PHI), revenue production, recency of maintenance, software version or patch level, and other factors, rather than becoming overwhelmed by alerts. Pulse may help the HDO measure and track the impact of a vulnerability and the progress of the remediation. BlueFlow may be designed to comply with FDA regulations and NIST standards for medical device security. Creating an enhanced feed to the HDOs would result in improved and more impactful communications about medical devices.

The feed also may be used internally by medical device manufacturers to eliminate internal information silos. Further, the information silos are an information management system that is unable to freely communicate with other information management systems. Within BlueFlow, the Software Bill of Materials (SBOM), containing information about the software on a device and its dependencies, may be added as another field that attaches to the medical device record, which would allow HDOs to track SBOMs and the risk environment.

BlueFlow Pulse exists to build portals to medical device manufacturers that would connect to the BlueFlow software which, in turn, would allow the manufacturer to send critical information directly to HDOs in a manner that is easy for HDOs to digest and act upon.

BlueFlow also could assist medical device manufacturers in:
The weighting and distribution of risk factors across its departments so that the manufacturer can prioritize its remediation, given the limitations on human resources; and
Creating criteria for consistently categorizing new threats by impact or likelihood.

Further, BlueFlow may provide detailed, quantitative, continuous risk assessment. Further, BlueFlow may unambiguously show safety, security, privacy risk Further, BlueFlow may provide a direct mapping to the standard risk framework risk=likelihood times impact. Further, BlueFlow may provide automatically updated when risk profile changes. Further, BlueFlow may automatically account for vulnerabilities. Further, BlueFlow may automatically account for mitigating controls.

Further, BlueFlow may automate the upkeep of risk profiles (assessments). Further, BlueFlow may allow risk assessments to update themselves in response to new threats (BlueFlow Pulse™ feed). Further, BlueFlow may automatically create assessment for new assets. Further, BlueFlow may provide feedback loop: live reports automatically reflect changes over time. Further, BlueFlow may facilitate continuous prioritization of risks. Further, BlueFlow may provide measurable, improvable progress. Further, BlueFlow may quickly find & fill assessment gaps. Further, BlueFlow may provide fully auditable criteria & metrics for risk assessment and performance of risk reduction over time. Further, BlueFlow may provide tunable risk assessment with customizable risk factors and weights. Further, BlueFlow may allow a customer or consultant to tune assessment criteria. Further, BlueFlow may allow to incorporate & weigh existing customer data, including biomedical assessments such as safety criticality. Further, BlueFlow may provide high-level reporting for management. Further, BlueFlow may provide performance indicators to drive security investment. Further, BlueFlow may provide categorization, grouping, tagging, and identification of medical devices along with the open-source Tapirx™ discovery tool. Further, BlueFlow may provide flexible user-defined risk assessment and scoring. Further, BlueFlow may provide threat feed for known medical devices. Further, BlueFlow may provide vulnerability management via integration with vulnerability scanners. Further, BlueFlow may provide reporting on risk and security properties for groups of assets. Further, BlueFlow can be used not only with medical devices but can be used with picture archiving and communications systems (PACS), the systems that store digital artifacts such as x-rays and MRI images. BlueFlow not only has uses in the medical device and PACs, but it can be used in other industries like industrial controls. Further, BlueFlow may provide measurable (quantifiable) cybersecurity risk assessments of medical devices. Further, BlueFlow may provide clear up-to-the-minute sense of priorities for all internal stakeholders.

Further, BlueFlow may provide meaningful reporting on security. Further, BlueFlow may provide customized risk scoring based on the customer's own criteria. Further, BlueFlow may provide detailed, quantitative, continuous risk assessment. Further, BlueFlow may unambiguously depict safety, security and privacy risk for assets in arbitrary configurations or groupings.

Further, BlueFlow may be used for providing software updates to the assets. Further, BlueFlow receives a cryptographically signed notification along with cryptographically signed software updates from a device (asset manufacturer). Further, BlueFlow may use manufacturer-specific channels to push the updates to the assets at predetermined times.

Further, the present disclosure may describe robust search function including searches for lack of information, e.g., assets without an IP address, saved searches for common “lacks information” queries, per-user saved searches, searches for open ports and edit and delete saved searches.

Further, the present disclosure may describe device onboarding that may include Software Bill of Material (SBOM) support functions, such as attaching SBOM files to assets, models and manufacturers, importing and interpreting SBOM contents, and searching on SBOM contents (e.g., show me all assets with openssl≤1.2.3″) and data cleaning workflows such as merging two similar assets or searching for duplicates and synchronization with external systems such as REST API token authentication and creating and updating assets from ServiceNow or another inventory-management system.

Further, the present disclosure describes the integration of BlueFlow with TapirX, Virta Labs' open-source tool for inventory discovery and identification of networked assets.

Further, the present disclosure describes remediation management to help customers keep track of problems and remediations by (a) grouping vulnerabilities together such as searching by asset type or finding all assets with a given vulnerability, (b) exporting vulnerabilities to a ticketing system, (c) tracking an asset's remediation history, and (d) fielding problem reports via a Virta Labs community API.

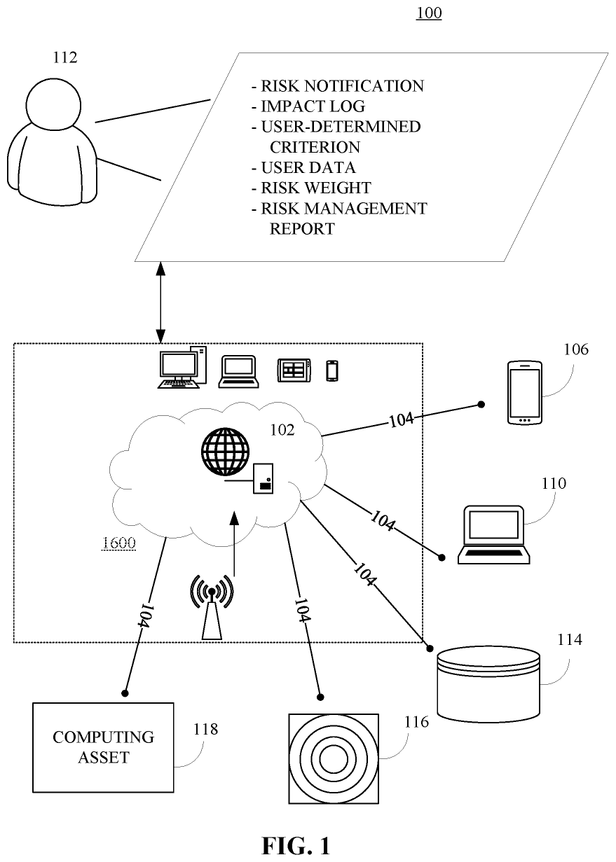

Referring now to figures, FIG. 1 is an illustration of an online platform 100 consistent with various embodiments of the present disclosure. By way of non-limiting example, the online platform 100 to facilitate cybersecurity risk management of computing assets may be hosted on a centralized server 102, such as, for example, a cloud computing service. The centralized server 102 may communicate with other network entities, such as, for example, a mobile device 106 (such as a smartphone, a laptop, a tablet, etc.), other electronic devices 110 (such as desktop computers, server computers, etc.), databases 114, sensors 116, and computing asset 118 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1600.

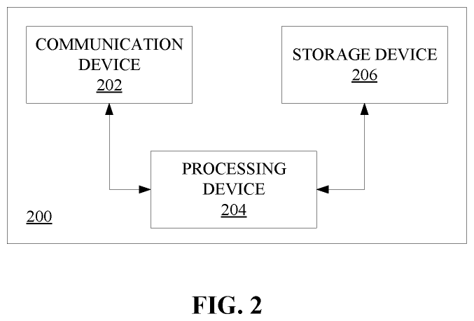

FIG. 2 is a block diagram of a system 200 for facilitating cybersecurity risk management of computing assets, in accordance with some embodiments. Accordingly, the system 200 may include a communication device 202, a processing device 204, and a storage device 206.

Further, the communication device 202 may be configured for receiving asset information from a computing asset. Further, the computing asset may be configured for generating the asset information. Further, the computing asset may include a medical device. Further, the medical device may include a computing device, a communication device, a sensor, etc. Further, the computing asset may include an object associated with a facility. Further, the object may include a desk, a bed, an air conditioner, a heater, etc. Further, the object may include a computing device, a processing device, a communication device, a sensor, etc. Further, the facility may include a hospital, an industry, an industrial plant, etc. Further, the computing asset may include medical devices such as, but not limited to, an ECG device, a CT-scan device, an X-ray device, an MRI device, etc. Further, the computing asset may include an infusion pump, industrial controller, etc. Further, the communication device 202 may be configured for transmitting a risk notification to at least one user device.

Further, the storage device 206 may be configured for retrieving secondary asset information associated with the computing asset from a third-party database.

Further, the processing device 204 may be configured for analyzing the asset information and the secondary asset information based on at least one predetermined criterion. Further, the processing device 204 may be configured for determining a risk profile corresponding to each predetermined criterion associated with the computing asset based on the analyzing. Further, the processing device 204 may be configured for generating the risk notification associated with the computing asset based on the determining.

Further, in some embodiments, the communication device 202 may be further configured for receiving additional asset information associated with the computing asset from an external device. Further, the processing device 204 may be further configured for analyzing the additional asset information based on the at least one predetermined criterion. Further, the determining of the risk profile corresponding to the each predetermined criterion associated with the computing asset based on the analyzing of the additional asset information based on the at least one predetermined criterion.

Further, in some embodiments, the computing asset may include a plurality of computing assets. Further, the communication device 202 may be further configured for receiving an asset attribute associated with each computing asset of the plurality of computing assets. Further, the processing device 204 may be further configured for analyzing the asset attribute. Further, the processing device 204 may be further configured for determining a priority rank associated with the each computing asset based on the analyzing of the asset attribute. Further, the processing device 204 may be further configured for identifying one or more actions associated with the each computing asset based on the determining. Further, the generating of the risk notification associated with the each computing asset may be based on the identifying.

Further, in some embodiments, the processing device 204 may be further configured for determining an impact of at least one of a vulnerability and a remediation action associated with the computing asset based on the analyzing. Further, the processing device 204 may be further configured for generating an impact log based on the determining of the impact of at least one of the vulnerability and the remediation action. Further, the impact log may include the impact associated with at least one of the vulnerability and the remediation action for each event of a plurality of events. Further, the communication device 202 may be further configured for transmitting the impact log to the at least one user device.

Further, in some embodiments, the asset information may include software bill of materials (SBOM) data. Further, the processing device 204 may be further configured for analyzing the software bill of materials data based on the at least one predetermined criterion. Further, the determining of the risk profile corresponding to the each predetermined criterion may be based on the analyzing of the software bill of materials data based on the at least one predetermined criterion.

Further, in some embodiments, the communication device 202 may be further configured for receiving network information from at least one network device. Further, the at least one network device may be communicatively coupled with the computing asset over at least one communication network. Further, the network information may be associated with the at least one communication network. Further, the processing device 204 may be further configured for modifying the asset information based on the network information. Further, the processing device 204 may be further configured for generating modified asset information based on the modifying. Further, the processing device 204 may be further configured for analyzing the modified asset information and the secondary asset information based on at least one predetermined criterion. Further, the determining of the risk profile corresponding to each predetermined criterion associated with the computing asset based on the analyzing of the modified asset information and the secondary asset information based on at least one predetermined criterion.

Further, in some embodiments, the communication device 202 may be further configured for receiving at least one user-determined criterion from the at least one user device. Further, the processing device 204 further configured for analyzing the asset information and the secondary asset information based on at least one user-determined criterion. Further, the determining of the risk profile corresponding to each user-determined criterion associated with the computing asset is based on the analyzing of the asset information and the secondary asset information.

Further, in some embodiments, the communication device 202 may be further configured for receiving at least one user data associated with the computing asset from the at least one user device. Further, the processing device 204 may be further configured for modifying the asset information associated with the computing asset based on the at least one user data. Further, the processing device 204 may be further configured for generating modified asset information based on the modifying. Further, the processing device 204 may be further configured for analyzing the modified asset information and the secondary asset information based on at least one predetermined criterion. Further, the determining of the risk profile corresponding to each predetermined criterion associated with the computing asset based on the analyzing of the modified asset information and the secondary asset information based on at least one predetermined criterion.

Further, in some embodiments, the communication device 202 may be further configured for receiving a risk weight corresponding to the at least one predetermined criterion from the at least one user device. Further, the processing device 204 may be further configured for modifying the at least one predetermined criterion based on the risk weight. Further, the processing device 204 may be further configured for generating at least one modified criterion based on the modifying. Further, the processing device 204 may be further configured for analyzing the asset information and the secondary asset information based on the at least one modified criterion. Further, the determining of the risk profile corresponding to each modified criterion associated with the computing asset based on the analyzing of the asset information and the secondary asset information based on the at least one modified criterion.

Further, in some embodiments, the processing device 204 may be further configured for analyzing the risk profile associated with the computing asset based on the at least one regulation data. Further, the processing device 204 may be further configured for generating a risk management report associated with the computing asset based on the analyzing of the risk profile based on the at least one regulation data. Further, the communication device 202 may be further configured for transmitting the risk management report to the at least one user device.

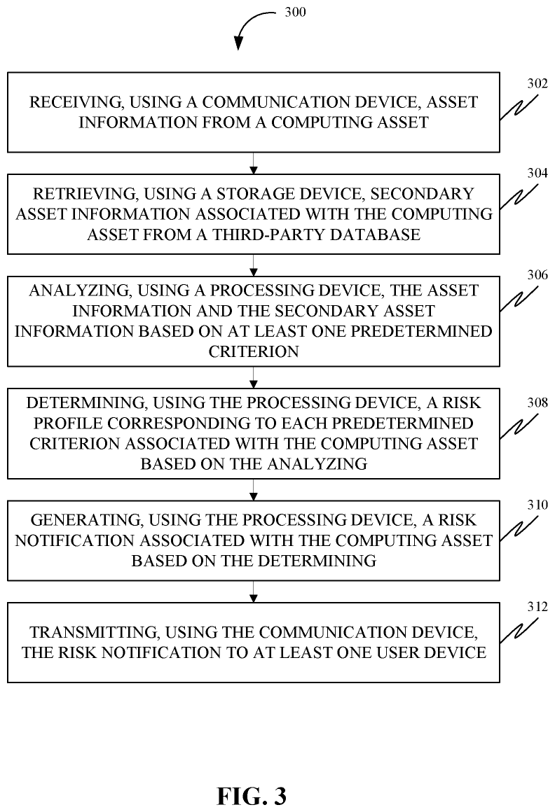

FIG. 3 is a flowchart of a method 300 for facilitating cybersecurity risk management of computing assets, in accordance with some embodiments. Accordingly, at 302, the method 300 may include a step of receiving, using a communication device, asset information from a computing asset. Further, the computing asset may be configured for generating the asset information. Further, the asset information may include health information, operating information of machinery in a plant, etc. Further, the health information may include a patient's history, lab results information, x-ray information, clinical information, etc. Further, the computing asset may include a medical device. Further, the medical device may include a computing device, a communication device, a sensor, etc. Further, the computing asset may include an object associated with a facility. Further, the object may include a desk, a bed, an air conditioner, a heater, etc. Further, the object may include a computing device, a processing device, a communication device, a sensor, etc. Further, the facility may include a hospital, an industry, an industrial plant, etc. Further, the computing asset may include medical devices such as, but not limited to, an ECG device, a CT-scan device, an X-ray device, an MRI device, etc. Further, the computing asset may include an infusion pump, industrial controller, etc. Further, the computing asset may include machinery such as, but not limited to, a nuclear reactor, a turbine, a generator, etc. that may be used in a nuclear power plant.

Further, at 304, the method 300 may include a step of retrieving, using a storage device, secondary asset information associated with the computing asset from a third-party database (such as databases 114).

Further, at 306, the method 300 may include a step of analyzing, using a processing device, the asset information and the secondary asset information based on at least one predetermined criterion. Further, the at least one predetermined criterion may be based on organizational policy, procedure, and capability.

Further, at 308, the method 300 may include a step of determining, using the processing device, a risk profile corresponding to each predetermined criterion associated with the computing asset based on the analyzing. Further, the each predetermined criterion may be associated with a risk. Further, the risk profile may include an occurrence of the risk and an impact of the risk. Further, the occurrence of the risk and the impact of the risk may be quantifiable. Further, the occurrence of the risk and the impact of the risk may be measured on at least one scale.

Further, at 310, the method 300 may include a step of generating, using the processing device, a risk notification associated with the computing asset based on the determining. Further, the risk notification may include the risk profile associated with the computing asset. Further, the risk notification may include a risk score associated with the computing asset. Further, the risk score may include a measure of risk occurrence and a measure of risk profile. Further, the risk notification may include a visualization of the risk profile for a period of time. Further, the risk notification may include software patches, alerts, security updates, etc.

Further, at 312, the method 300 may include a step of transmitting, using the communication device, the risk notification to at least one user device. Further, the at least one user device may be associated with at least one user (such as user 112). Further, the at least one user may include an individual, an institution, an organization, etc. that may want to receive the risk notification. Further, the at least one user device may include a smartphone, a laptop, a personal computer, a tablet, etc. Further, the at least one user device is configured for presenting the risk notification to the at least one user.

In some embodiments, the at least one user device may include the computing asset. Accordingly, the risk notification may be transmitted to the computing asset. Accordingly, in some instances, a software patch may be directly transmitted to the computing asset in the form of the risk notification.

Further, in some embodiment, the asset information may include software bill of materials data. Further, the method 300 may include a step of analyzing, using the processing device, the software bill of materials data based on the at least one predetermined criterion. Further, the determining of the risk profile corresponding to the each predetermined criterion may be based on the analyzing of the software bill of materials based on the at least one predetermined criterion

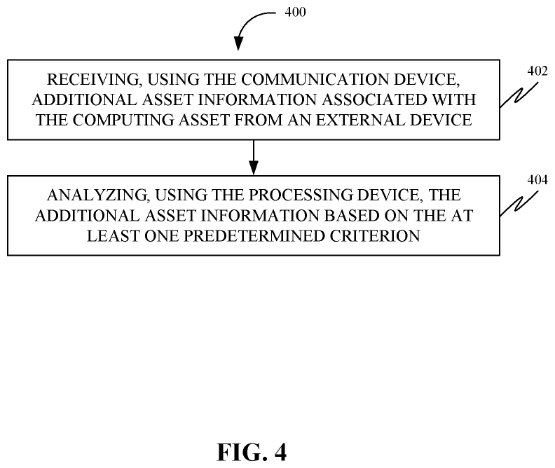

FIG. 4 is a flowchart of a method 400 of facilitating the determination of a risk profile based on additional asset information, in accordance with some embodiments. Accordingly, at 402, the method 400 may include a step of receiving, using the communication device, additional asset information associated with the computing asset from an external device. Further, the computing asset may be associated with at least one asset specification. Further, the at least one asset information may include an asset model, an asset manufacturer, etc. Further, the additional asset information may be specific to the at least one asset specification. Further, the external device may be associated with at least one external user. Further, the at least one external user may include an individual, an institution, an organization, etc. Further, the external device may include a smartphone, a laptop, a personal computer, a tablet, etc.

Further, at 404, the method 400 may include a step of analyzing, using the processing device, the additional asset information based on the at least one predetermined criterion. Further, the determining of the risk profile corresponding to the each predetermined criterion associated with the computing asset based on the analyzing of the additional asset information based on the at least one predetermined criterion.

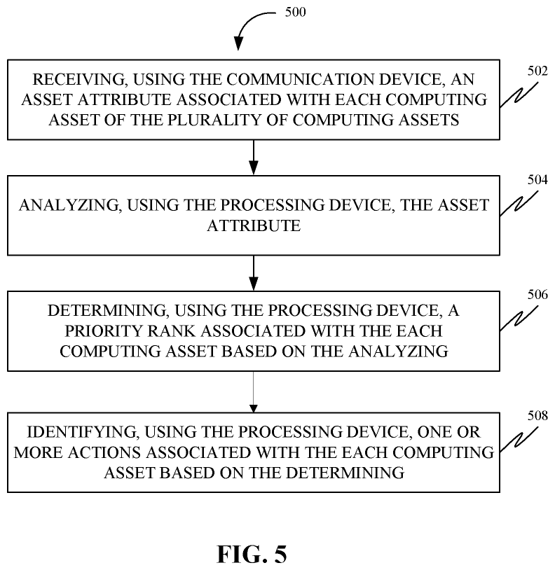

FIG. 5 is a flowchart of a method 500 for facilitating the determination of priority of computing assets for performing actions, in accordance with some embodiments. Accordingly, at 502, the method 500 may include a step of receiving, using the communication device, an asset attribute associated with each computing asset of a plurality of computing assets from the each computing asset.

Further, at 504, the method 500 may include a step of analyzing, using the processing device, the asset attribute.

Further, at 506, the method 500 may include a step of determining, using the processing device, a priority rank associated with the each computing asset based on the analyzing of the asset attribute. Further, the priority rank may include a low rank, a high rank, etc.

Further, at 508, the method 500 may include a step of identifying, using the processing device, one or more actions associated with the each computing asset based on the determining. Further, the generating of the risk notification associated with the each computing asset may be based on the identifying. Further, the risk notification may include the one or more actions to be performed on the computing asset based on the priority rank associated with the computing asset. Further, the one or more actions associated with the computing asset with the low rank has lower priority compared to the one or more actions associated with the computing asset with the high rank.

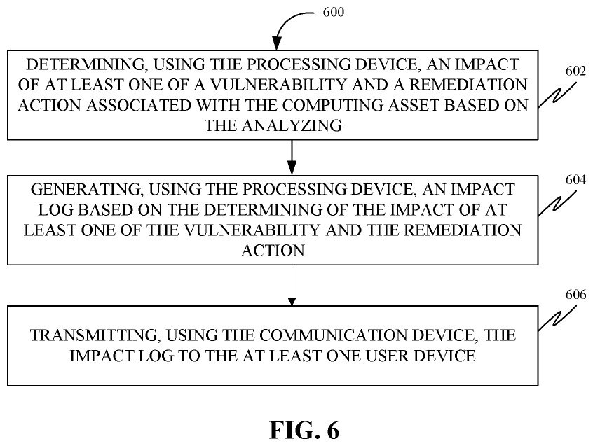

FIG. 6 is a flowchart of a method 600 for facilitating the generation of an impact log for a vulnerability and a remediation action, in accordance with some embodiments. Accordingly, at 602, the method 600 may include a step of determining, using the processing device, an impact of at least one of a vulnerability and a remediation action associated with the computing asset based on the analyzing.

Further, at 604, the method 600 may include a step of generating, using the processing device, an impact log based on the determining of the impact of at least one of the vulnerability and the remediation action. Further, the impact log may include the impact associated with at least one of the vulnerability and the remediation action for each event of a plurality of events.

Further, at 606, the method 600 may include a step of transmitting, using the communication device, the impact log to the at least one user device.

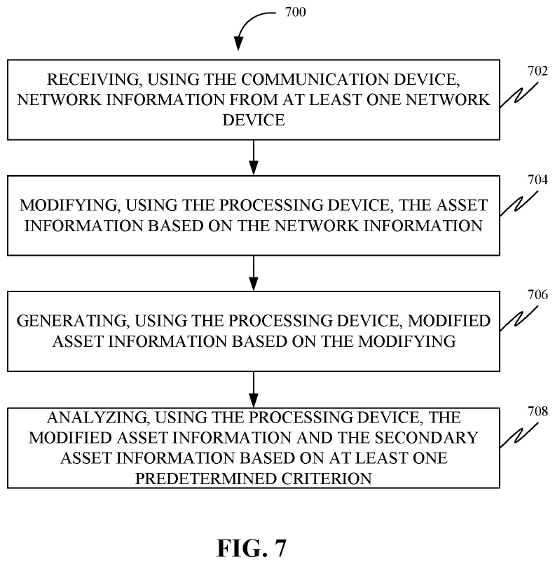

FIG. 7 is a flowchart of a method 700 for facilitating the determination of a risk profile associated with a computing asset based on network information of the computing asset, in accordance with some embodiments. Accordingly, at 702, the method 700 may include a step of receiving, using the communication device, network information from at least one network device. Further, the at least one network device may be communicatively coupled with the computing asset over at least one communication network. Further, the network information may be associated with the at least one communication network.

Further, at 704, the method 700 may include a step of modifying, using the processing device, the asset information based on the network information.

Further, at 706, the method 700 may include a step of generating, using the processing device, modified asset information based on the modifying.

Further, at 708, the method 700 may include a step of analyzing, using the processing device, the modified asset information and the secondary asset information based on at least one predetermined criterion. Further, the determining of the risk profile corresponding to each predetermined criterion associated with the computing asset based on the analyzing of the modified asset information and the secondary asset information based on at least one predetermined criterion.

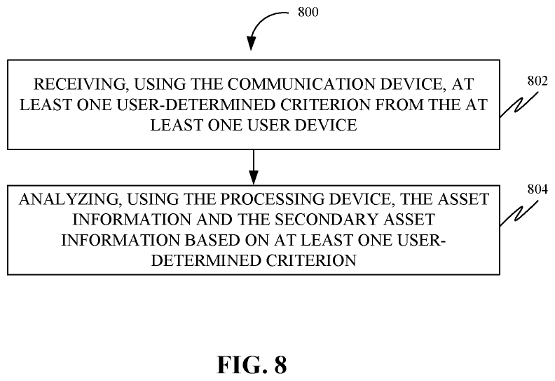

FIG. 8 is a flowchart of a method 800 for facilitating the determination of a risk profile based on a user-determined criterion, in accordance with some embodiments. Accordingly, at 802, the method 800 may include a step of receiving, using the communication device, at least one user-determined criterion from the at least one user device.

Further, at 804, the method 800 may include a step of analyzing, using the processing device, the asset information and the secondary asset information based on at least one user-determined criterion. Further, the determining of the risk profile corresponding to each user-determined criterion associated with the computing asset based on the analyzing of the asset information and the secondary asset information based on at least one user-determined criterion

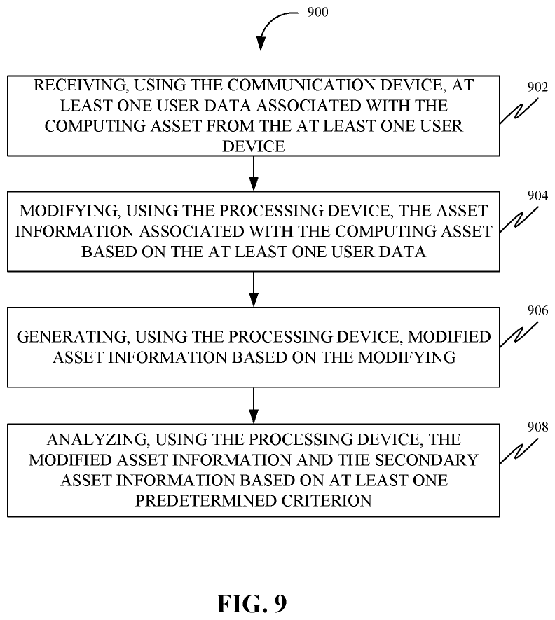

FIG. 9 is a flowchart of a method 900 for facilitating the determination of a risk profile associated with a computing asset based on user data, in accordance with some embodiments. Accordingly, at 902, the method 900 may include a step of receiving, using the communication device, at least one user data associated with the computing asset from the at least one user device. Further, the at least one user data may include software updates, security patches, security alerts, etc.

Further, at 904, the method 900 may include a step of modifying, using the processing device, the asset information associated with the computing asset based on the at least one user data.

Further, at 906, the method 900 may include a step of generating, using the processing device, modified asset information based on the modifying.

Further, at 908, the method 900 may include a step of analyzing, using the processing device, the modified asset information and the secondary asset information based on at least one predetermined criterion. Further, the determining of the risk profile corresponding to each predetermined criterion associated with the computing asset based on the analyzing of the modified asset information and the secondary asset information based on at least one predetermined criterion.

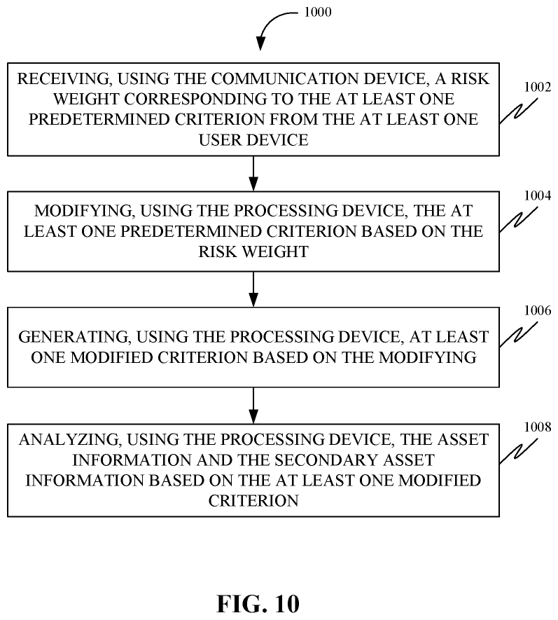

FIG. 10 is a flowchart of a method 1000 for facilitating the modification of a predetermined criterion based on a risk weight, in accordance with some embodiments. Accordingly, at 1002, the method 1000 may include a step of receiving, using the communication device, a risk weight corresponding to the at least one predetermined criterion from the at least one user device.

Further, at 1004, the method 1000 may include a step of modifying, using the processing device, the at least one predetermined criterion based on the risk weight.

Further, at 1006, the method 1000 may include a step of generating, using the processing device, at least one modified criterion based on the modifying.

Further, at 1008, the method 1000 may include a step of analyzing, using the processing device, the asset information and the secondary asset information based on the at least one modified criterion. Further, the determining of the risk profile corresponding to each modified criterion associated with the computing asset based on the analyzing of the asset information and the secondary asset information based on the at least one modified criterion.

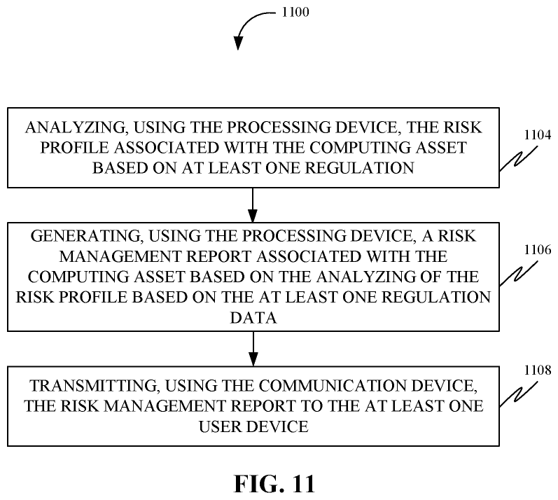

FIG. 11 is a flowchart of a method 1100 for facilitating the generation of a risk management report based on a regulation, in accordance with some embodiments. Accordingly, at 1104, the method 1100 may include a step of analyzing, using the processing device, the risk profile associated with the computing asset based on at least one regulation data. Further, the at least one regulation data may be associated with NIST Cybersecurity Framework (CSF), NIST practice guide, FDA regulations, etc. Further, the at least one regulation data may be associated with at least one regulatory body. Further, the at least one regulatory body may include the Office of Civil rights of the Department of the Health and Human Services (HHS OCR).

Further, at 1106, the method 1100 may include a step of generating, using the processing device, a risk management report associated with the computing asset based on the analyzing of the risk profile based on the at least one regulation data.

Further, at 1108, the method 1100 may include a step of transmitting, using the communication device, the risk management report to the at least one user device.

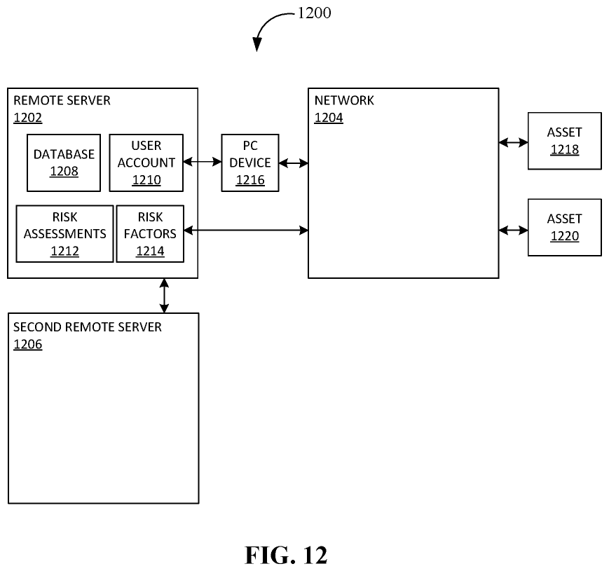

FIG. 12 is a block diagram of a system 1200 of facilitating cybersecurity risk management of computing assets, in accordance with some embodiments. Further, the system 1200 may include a remote server 1202, at least one personal computing (PC) device 1216, a plurality of assets (computing assets) 1218-1220, and a vulnerability-scanning software (not shown). Further, the remote server 1202 may be used to manage risk assessments 1212 and to store information provided by a user account 1210 and for each of the plurality of assets 1218-1220. Further, the remote server 1202 may be connected to a network 1204 of the at least one personal computing (PC) device 1216 in order to process and manage the risk assessments 1212. Further, the at least one personal computing (PC) device 1216 may allow a user to provide information of each of the plurality of assets 1218-1220, edit any provided information, and to view the results of the risk assessment 1212. Further, the at least one personal computing (PC) device 1216 may be any computing device such as, but not limited to, a personal desktop computer, a laptop computer, a mobile tablet device or a mobile phone device. Further, the plurality of assets 1218-1220 may be devices that may be associated with a specific facility and that may be managed by an online system. For example, the plurality of assets 1218-1220 may be, but are not limited to, medical devices of a medical facility or machinery used in a nuclear power plant. Further, the vulnerability-scanning software may be used to measure the vulnerability of each asset and may be commonly sold as off-the-shelf software independent of the assets being scanned.

Further, the system 1200 may include a second remote server 1206. Further, the second remote server 1206 may be used to acquire and provide new information on any of the plurality of assets 1218-1220. Further, the remote server 1202 may include the second remote server 1206. Further, the second remote server 1206 continually searches for new information of at least one specific asset of the plurality of assets 1218-1220. Further, the new information on the at least one specific asset may be relayed to the remote server 1202 from the second remote server 1206.

Further, the new information about each of the plurality of assets 1218-1220 may be provided through the at least one personal computing (PC) device 1216 in concert with local databases 1208 of asset information operated by the user account 1210, the aforementioned vulnerability-scanning software, and one or more threat feed fetched from external services. Using the provided information, the remote server 1202 semi-automatically defines a set of risk factors 1214 for each of the plurality of assets 1218-1220.

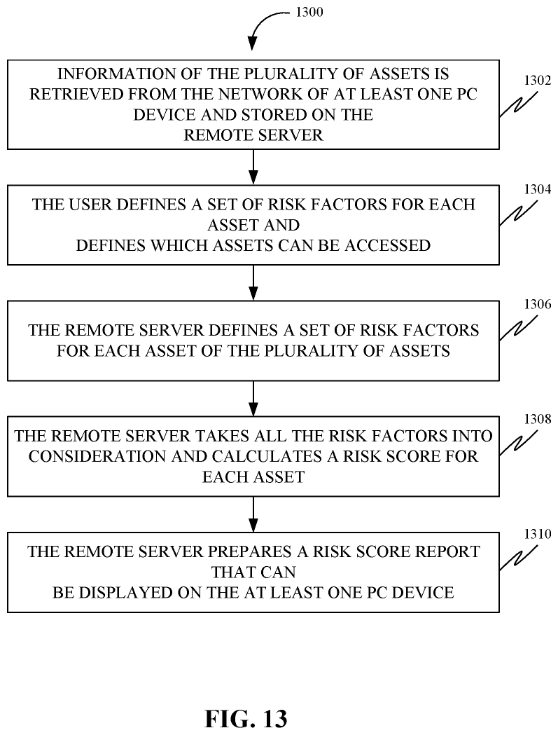

FIG. 13 is a flowchart of a method 1300 of facilitating cybersecurity risk management of computing assets, in accordance with some embodiments. Accordingly, at 1302, the method 1300 may include a step of retrieving information of the plurality of assets (such as computing asset) from the network of at least one PC device and storing on a remote server. Further, the at least one PC device may be an instance of the at least one user device. Further, the method 1300 may include an overall process for the risk assessment of the plurality of assets. Information about each of the plurality of assets may be provided through the at least one PC device in concert with local databases of asset information operated by a user, the aforementioned vulnerability-scanning software, and one or more threat feed fetched from external services. This information may be the default security and risk assessment information of an associated network of the at least one PC device.

Further, at 1304, the method 1300 may include a step of defining a set of risk factors for each asset and which asset can be accessed. In further detail, the default security and risk assessment information may be information obtained from a third-party security risk assessment software. The provided information may be relayed to the remote server and stored on the remote server. Further, the remote server may continuously monitor the plurality of assets.

Further, at 1306, the method 1300 may include a step of defining a set of risk factors for each asset of the plurality of assets. Using the provided information, the remote server semi-automatically defines a set of risk factors for each of the plurality of assets. Furthermore, the user may define risk factors based on organizational policies, procedures, and capability and define which assets can be accessed. Further, the risk factors may be but are not limited to, that an arbitrary asset of the plurality of assets is a legacy device that anti-virus cannot be installed on, or an arbitrary asset is a critical care device which includes private patient data. Other risk factors may include, but are not limited to, Common Vulnerability Scoring System (CVSS) scores of vulnerabilities, clinical risk/priority scores from Computerized Maintenance Management System (CMMS) sources, local population measurements, application of compensating or mitigating controls, and results of custom, low-impact vulnerability probes, and checks. Further, a user of the at least one PC device may provide a risk measurement for each asset if desired, can customize the set of risk factors, or edit information on the plurality of assets based on current conditions. Further, the set of risk factors and user-provided information may be compiled by the remote server.

Further, at 1308, the method 1300 may include a step of taking all the risk factors into consideration and calculating a risk score for each asset by the remote server. Further, the remote server may calculate a risk score for each of the plurality of assets and may generate a risk information page for each of the plurality of assets. Further, the risk score may be calculated as a weighted sum of the set of risk factors for each asset, the weights having been defined previously by the user in a configuration menu. Further, the risk information page may include the corresponding risk score and the corresponding risk factors for each asset. Further, each information page may be displayed on the at least one PC device. Further, the risk assessment for the asset is created from a weighted combination of risk factors. Further, mitigating controls can be configured. Further, mitigating controls may include negative risk factors. Further, the negative risk factor reduces the risk. Further, the risk factors may be associated with a plurality of risk factor types. Further, the risk factor types may include boolean (yes/no), numeric range (0 to 10), and named set of options (e.g., “very low”, “low”, “medium”, “high”). Further, risk factor weights are configurable according to organizational preferences/priorities. Further, the risk factor weights may always sum to 100%. Further, the risk factors can be configured to have default values. For example, the operator can build into BlueFlow a default assumption that an asset is missing an “antivirus” control.

Further, at 1310, the method 1300 may include a step of preparing a risk score report that can be displayed on the at least one PC device. Further, the remote server then compiles each information page and generates a risk assessment report for the plurality of assets. Further, the risk information includes the risk score for each asset, viable information on each asset, and recommendations on steps the user should take to fully protect each asset. Further, the risk assessment report may include graphics that easily represent information such as, but not limited to, the weight of risk factors or vulnerabilities of each asset. Further, the risk assessment report may be accessed and displayed on the at least one PC device.

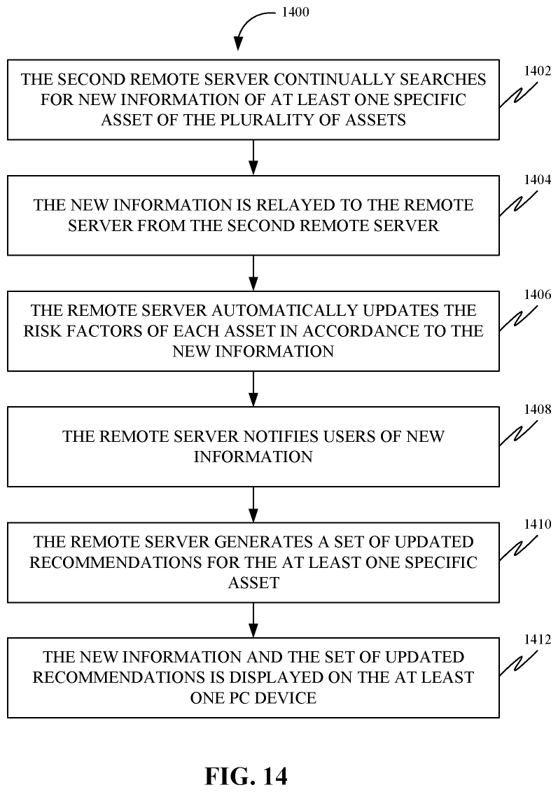

FIG. 14 is a flowchart of a method 1400 of “Pulse Feed” sub-process, in accordance with some embodiments. Accordingly, at 1402, the method 1400 may include a step of searching new information of at least one specific asset (computing asset) of the plurality of assets. Further, a second remote server may be used to acquire and provide new information on any of the plurality of assets. Further, the second remote server may continually search for the new information associated with the at least one specific asset of the plurality of assets.

Further, at 1404, the method 1400 may include a step of relaying the new information to the remote server from the second remote server. The new information on the at least one specific asset is relayed to the remote server from the second remote server.

Further, at 1406, the method 1400 may include a step of updating the risk factors of each asset in accordance to the new information. When the remote server receives the new information for the at least one specific asset, the remote server automatically updates the risk score of the at least one specific asset in accordance to the new information.

Further, at 1408, the method 1400 may include a step of notifying a user of new information by the remote server.

Further, at 1410, the method 1400 may include a step of generating a set of updated recommendations for the at least one specific asset by the remote server.

Further, at 1412, the method 1400 may include a step of displaying the new information and the set of updated recommendations on the at least one PC device. Further, the new information and the set of updated recommendations may be displayed on the PC device. If the calculated risk score is high for an asset, relevant signals include, but are not limited to, CVSS score indicating an elevated threat to availability, in particular, high clinical priority indicated in the CMMS, vulnerability scanning results indicating high CVSS scores, presence of similar assets with higher risk scores on the same network segment, and/or the last vulnerability scan is too far in the past. If the calculated risk score is low for an asset, relevant signals include low or no clinical priority indicated in CMMS, low or no priority for business continuity, vulnerability scanning results indicating low score, and/or deploying a compensating control and re-testing.

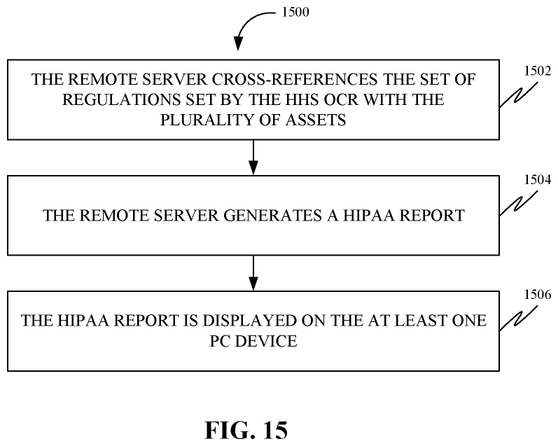

FIG. 15 is a flowchart of a method 1500 of “Health Insurance Portability and Accountability Act (HIPAA) Report” sub-process, in accordance with some embodiments. Accordingly, at 1502, the method 1500 may include a step of cross-referencing the set of regulations set by the HHS OCR with the plurality of assets (computing assets) by the remote server. Further, the “Health Insurance Portability and Accountability Act (HIPAA) Report” sub-process may educate users on the regulations set by the Office of Civil rights of the Department of the Health and Human Services (HHS OCR). Further, the “HIPAA Report” sub-process may be particular to medical facilities that have access to private patient data. Further, the remote server cross-references the set of regulations set by the department of human services with the plurality of assets.

Further, at 1504, the method 1500 may include a step of generating a “HIPAA Report” by the remote server. Afterward, the remote server generates the “HIPAA Report” which includes information describing what users may be able to do to assets to avoid violating HIPAA regulations protecting patient privacy. For example, users may be recommended to install anti-virus on at least one specific asset based on the “HIPAA Report”.

Further, at 1506, the method 1500 may include a step of displaying the “HIPAA Report” on the at least one PC device.

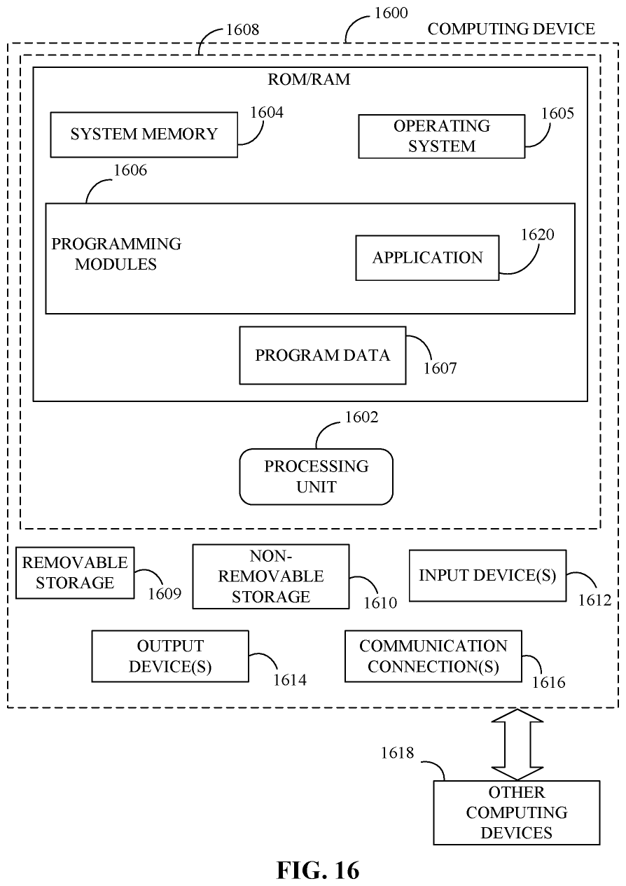

With reference to FIG. 16, a system consistent with an embodiment of the disclosure may include a computing device or cloud service, such as a computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating cybersecurity risk management of a computing asset, the method comprising:
receiving, using a communication device, asset information from a computing asset, wherein the computing asset is configured for generating the asset information;
retrieving, using a storage device, secondary asset information associated with the computing asset from a third-party database;
analyzing, using a processing device, the asset information and the secondary asset information based on at least one predetermined criterion;
determining, using the processing device, a risk profile corresponding to each predetermined criterion associated with the computing asset based on the analyzing;
generating, using the processing device, a risk notification associated with the computing asset based on the determining; and
transmitting, using the communication device, the risk notification to at least one user device.

2. The method of claim 1 further comprising:
receiving, using the communication device, additional asset information associated with the computing asset from an external device; and
analyzing, using the processing device, the additional asset information based on the at least one predetermined criterion, wherein the determining of the risk profile corresponding to the each predetermined criterion associated with the computing asset based on the analyzing of the additional asset information based on the at least one predetermined criterion.

3. The method of claim 1, wherein the computing asset comprises a plurality of computing assets, wherein the method further comprising:
receiving, using the communication device, an asset attribute associated with each computing asset of the plurality of computing assets from the each computing asset;
analyzing, using the processing device, the asset attribute;
determining, using the processing device, a priority rank associated with the each computing asset based on the analyzing of the asset attribute; and
identifying, using the processing device, one or more actions associated with the each computing asset based on the determining, wherein the generating of the risk notification associated with the each computing asset is based on the identifying.

4. The method of claim 1 further comprising:
determining, using the processing device, an impact of at least one of a vulnerability and a remediation action associated with the computing asset based on the analyzing;
generating, using the processing device, an impact log based on the determining of the impact of at least one of the vulnerability and the remediation action, wherein the impact log comprises the impact associated with at least one of the vulnerability and the remediation action for each event of a plurality of events; and
transmitting, using the communication device, the impact log to the at least one user device.

5. The method of claim 1, wherein the asset information comprises software bill of materials (SBOM) data, wherein the method further comprises analyzing, using the processing device, the software bill of materials data based on the at least one predetermined criterion, wherein the determining of the risk profile corresponding to the each predetermined criterion is based on the analyzing of the software bill of materials.

6. The method of claim 1 further comprising:
receiving, using the communication device, network information from at least one network device, wherein the at least one network device is communicatively coupled with the computing asset over at least one communication network, wherein the network information is associated with the at least one communication network;
modifying, using the processing device, the asset information based on the network information;
generating, using the processing device, modified asset information based on the modifying; and
analyzing, using the processing device, the modified asset information and the secondary asset information based on at least one predetermined criterion, wherein the determining of the risk profile corresponding to each predetermined criterion associated with the computing asset based on the analyzing of the modified asset information and the secondary asset information based on at least one predetermined criterion.

7. The method of claim 1 further comprising:
receiving, using the communication device, at least one user-determined criterion from the at least one user device; and
analyzing, using the processing device, the asset information and the secondary asset information based on at least one user-determined criterion, wherein the determining of the risk profile corresponding to each user-determined criterion associated with the computing asset based on the analyzing of the asset information and the secondary asset information based on at least one user-determined criterion.

8. The method of claim 1 further comprising:
receiving, using the communication device, at least one user data associated with the computing asset from the at least one user device;
modifying, using the processing device, the asset information associated with the computing asset based on the at least one user data;
generating, using the processing device, modified asset information based on the modifying; and
analyzing, using the processing device, the modified asset information and the secondary asset information based on at least one predetermined criterion, wherein the determining of the risk profile corresponding to each predetermined criterion associated with the computing asset based on the analyzing of the modified asset information and the secondary asset information based on at least one predetermined criterion.

9. The method of claim 1 further comprising:
receiving, using the communication device, a risk weight corresponding to the at least one predetermined criterion from the at least one user device;
modifying, using the processing device, the at least one predetermined criterion based on the risk weight;
generating, using the processing device, at least one modified criterion based on the modifying; and
analyzing, using the processing device, the asset information and the secondary asset information based on the at least one modified criterion, wherein the determining of the risk profile corresponding to each modified criterion associated with the computing asset based on the analyzing of the asset information and the secondary asset information based on the at least one modified criterion.

10. The method of claim 1 further comprising:
analyzing, using the processing device, the risk profile associated with the computing asset based on at least one regulation data;
generating, using the processing device, a risk management report associated with the computing asset based on the analyzing of the risk profile based on the at least one regulation data; and
transmitting, using the communication device, the risk management report to the at least one user device.

11. A system for facilitating cybersecurity risk management of a computing asset, the system comprising:
a communication device configured for:
receiving asset information from a computing asset, wherein the computing asset is configured for generating the asset information; and
transmitting a risk notification to at least one user device;
a storage device configured for retrieving secondary asset information associated with the computing asset from a third-party database;
a processing device configured for:
analyzing the asset information and the secondary asset information based on at least one predetermined criterion;
determining a risk profile corresponding to each predetermined criterion associated with the computing asset based on the analyzing; and
generating the risk notification associated with the computing asset based on the determining.

12. The system of claim 11, wherein the communication device is further configured for receiving additional asset information associated with the computing asset from an external device, wherein the processing device is further configured for analyzing the additional asset information based on the at least one predetermined criterion, wherein the determining of the risk profile corresponding to the each predetermined criterion associated with the computing asset based on the analyzing of the additional asset information based on the at least one predetermined criterion.

13. The system of claim 11, wherein the computing asset comprises a plurality of computing assets, wherein the communication device is further configured for receiving an asset attribute associated with each computing asset of the plurality of computing assets from the each computing asset, wherein the processing device is further configured for:
analyzing the asset attribute;
determining a priority rank associated with the each computing asset based on the analyzing of the asset attribute; and
identifying one or more actions associated with the each computing asset based on the determining, wherein the generating of the risk notification associated with the each computing asset is based on the identifying.

14. The system of claim 11, wherein the processing device further configured for:
determining an impact of at least one of a vulnerability and a remediation action associated with the computing asset based on the analyzing; and
generating an impact log based on the determining of the impact of at least one of the vulnerability and the remediation action, wherein the impact log comprises the impact associated with at least one of the vulnerability and the remediation action for each event of a plurality of events, wherein the communication device is further configured for transmitting the impact log to the at least one user device.

15. The system of claim 11, wherein the asset information comprises software bill of materials (SBOM) data, wherein the processing device is further configured for analyzing the software bill of materials data based on the at least one predetermined criterion, wherein the determining of the risk profile corresponding to the each predetermined criterion is based on the analyzing of the software bill of materials.

16. The system of claim 11, wherein the communication device is further configured for receiving network information from at least one network device, wherein the at least one network device is communicatively coupled with the computing asset over at least one communication network, wherein the network information is associated with the at least one communication network, wherein the processing device is further configured for:
modifying the asset information based on the network information;
generating modified asset information based on the modifying; and
analyzing the modified asset information and the secondary asset information based on at least one predetermined criterion, wherein the determining of the risk profile corresponding to each predetermined criterion associated with the computing asset based on the analyzing of the modified asset information and the secondary asset information based on at least one predetermined criterion.

17. The system of claim 11, wherein the communication device is further configured for receiving at least one user-determined criterion from the at least one user device, wherein the processing device further configured for analyzing the asset information and the secondary asset information based on at least one user-determined criterion, wherein the determining of the risk profile corresponding to each user-determined criterion associated with the computing asset based on the analyzing of the asset information and the secondary asset information based on at least one user-determined criterion.

18. The system of claim 11, wherein the communication device is further configured for receiving at least one user data associated with the computing asset from the at least one user device, wherein the processing device is further configured for:
modifying the asset information associated with the computing asset based on the at least one user data;
generating modified asset information based on the modifying; and
analyzing the modified asset information and the secondary asset information based on at least one predetermined criterion, wherein the determining of the risk profile corresponding to each predetermined criterion associated with the computing asset based on the analyzing of the modified asset information and the secondary asset information based on at least one predetermined criterion.

19. The system of claim 11, wherein the communication device is further configured for receiving a risk weight corresponding to the at least one predetermined criterion from the at least one user device, wherein the processing device is further configured for:
modifying the at least one predetermined criterion based on the risk weight;
generating at least one modified criterion based on the modifying; and
analyzing the asset information and the secondary asset information based on the at least one modified criterion, wherein the determining of the risk profile corresponding to each modified criterion associated with the computing asset based on the analyzing of the asset information and the secondary asset information based on the at least one modified criterion.

20. The system of claim 11, wherein the processing device is further configured for:
analyzing the risk profile associated with the computing asset based on the at least one regulation data; and
generating a risk management report associated with the computing asset based on the analyzing of the risk profile based on the at least one regulation data, wherein the communication device is further configured for transmitting the risk management report to the at least one user device
